(19) United States
(12) Patent Application Publication
(10) Pub. No.: US 2025/0146238 A1
(43) Pub. Date: May 8, 2025

(54) ROAD SURFACE EVALUATION APPARATUS

(71) Applicant: Honda Motor Co., Ltd., Tokyo (JP)

(72) Inventors: Hiroyuki Onimaru, Tokyo (JP); Takeo Tokunaga, Tokyo (JP); Atsuki Kakinuma, Tokyo (JP); Yasuo Oishi, Tokyo (JP); Akira Iihoshi, Tokyo (JP)

(21) Appl. No.: 18/835,722

(22) PCT Filed: Feb. 8, 2023
(86) PCT No.: PCT/JP2023/004166

§ 371 Date: Aug. 3, 2024

(30) Foreign Application Priority Data
Feb. 10, 2022 (JP) 2022-019140

(51) Int. Cl. E01C 23/01; G01C 21/00; G07C 5/02

(52) U.S. Cl. CPC E01C 23/01; G01C 21/3815; G01C 21/3837; G01C 21/3859; G07C 5/02

(57) ABSTRACT

A road surface evaluation apparatus includes a microprocessor configured to perform: acquiring driving information of a vehicle which is traveling including acceleration information, speed information, and position information of the vehicle, acquiring map information including information on a road on which the vehicle travels, acquiring weather information including information relating to weather; deriving a road surface roughness value representing roughness of a road surface on which the vehicle travels based on the driving information of the vehicle estimating the weather in a section where the vehicle has traveled based on the weather information to correct the road surface roughness value based on the estimation result; and outputting the road surface roughness value in association with the information on the road.

### CROSS-REFERENCE TO RELATED APPLICATION

This application is a National Stage of PCT international application Ser. No. PCT/JP2023/004166 filed on Feb. 8, 2023 which designates the United States, incorporated herein by reference, and which is based upon and claims the benefit of priority from Japanese Patent Application No. 2022-019140, filed on Feb. 10, 2022, the entire contents of which are incorporated herein by reference.

### TECHNICAL FIELD

This invention relates to a road surface evaluation apparatus that evaluates a road surface profile representing unevenness of a road surface.

As a prior-art apparatus of this type, it is known that a road surface profile representing the unevenness of the road surface on which a vehicle has traveled is detected based on the acceleration in the lateral direction (lateral to the driving direction) measured by an acceleration sensor installed in the vehicle (see, for example, Patent Literature 1).

### CITATION LIST

### Patent Literature

Patent Literature 1: Japanese Unexamined Patent Publication No. 2002-12138

However, a condition of a road surface changes depending on weather such as rain or snow. Hence, a road surface profile detected based on an acceleration measured by an acceleration sensor will vary depending on a weather condition of a section in which a vehicle travels. Therefore, simply detecting the road surface profile based on the acceleration measured by the acceleration sensor, as in the apparatus described in Patent Literature 1 above, does not sufficiently evaluate the road surface profile.

### MEANS FOR SOLVING PROBLEM

An aspect of the present invention is a road surface evaluation apparatus including: a driving information acquisition unit configured to acquire driving information of a vehicle which is traveling including acceleration information indicating accelerations of the vehicle, speed information indicating driving speed of the vehicle, and position information of the vehicle; the map information acquisition unit configured to acquire map information including information on a road on which the vehicle travels; a weather information acquisition unit configured to acquire weather information including information relating to a weather; a roughness value derivation unit configured to derive a road surface roughness value representing roughness of a road surface on which the vehicle travels based on the driving information of the vehicle acquired by the driving information acquisition unit; a roughness value correction unit configured to estimate a weather in a section where the vehicle has traveled based on the weather information acquired by the weather information acquisition unit to correct the road surface roughness value derived by the roughness value derivation unit based on the estimation result; and an output unit configured to output the road surface roughness value corrected by the roughness value correction unit in association with the information on the road acquired by the map information acquisition unit.

### EFFECT OF THE INVENTION

The present invention allows adequate evaluation of road surface profiles.

### BRIEF DESCRIPTION OF THE DRAWINGS

FIG. 1 is a diagram illustrating an example of a configuration of a road surface evaluation system including a road surface evaluation apparatus according to an embodiment of the present invention;

FIG. 2 is a block diagram illustrating key components of an in-vehicle device.

FIG. 3 is a block diagram illustrating key components of the road surface evaluation apparatus according to the embodiment of the present invention;

FIG. 4A is a diagram illustrating how the correlation between road surface roughness values and lateral acceleration is derived;

FIG. 4B is a diagram illustrating how the correlation between road surface roughness values and lateral acceleration is derived;

FIG. 5A is a diagram illustrating an example of a map of a road on which a vehicle is driving;

FIG. 5B is a diagram illustrating an example of driving information acquired by the road surface evaluation apparatus from the in-vehicle device of the vehicle that has traveled the road in FIG. 5A;

FIG. 6 is a diagram illustrating an example of a road surface roughness value;

FIG. 7 is a diagram illustrating an example of weather information of the road in FIG. 5A; and

FIG. 8 is a flowchart illustrating an example of processing executed by the processing unit in FIG. 3.

### DESCRIPTION OF EMBODIMENT

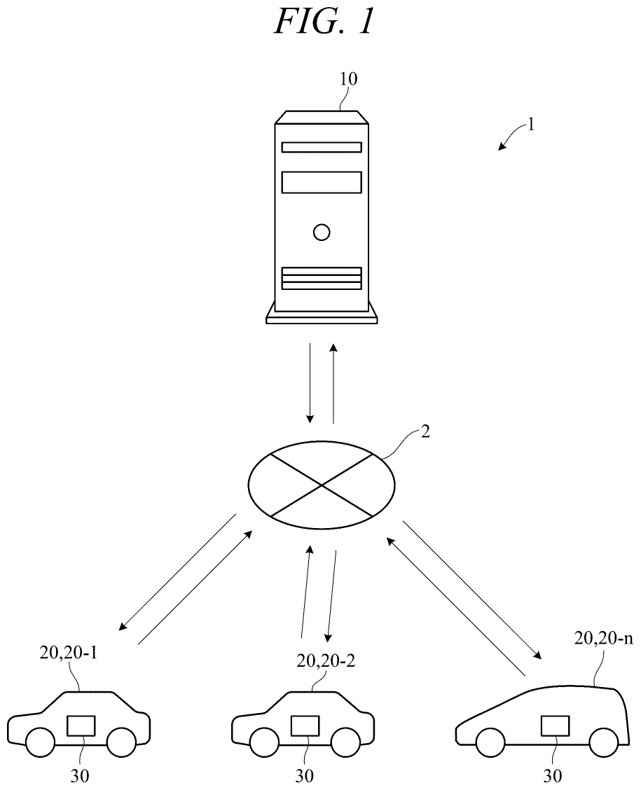

An embodiment of the present invention will be described below with reference to FIGS. 1 to 8. The road surface evaluation apparatus according to the present embodiment is an apparatus for evaluating the road surface profile of a road on which a vehicle is traveling. FIG. 1 illustrates an example of the configuration of a road surface evaluation system including a road surface evaluation apparatus according to the present embodiment. As illustrated in FIG. 1, the road surface evaluation system 1 includes a road surface evaluation apparatus 10 and an in-vehicle device 30. The road surface evaluation apparatus 10 is configured as a server device. The in-vehicle device 30 is configured to communicate with the road surface evaluation apparatus 10 via a communication network 2.

The communication network 2 includes not only public wireless communication networks represented by Internet networks and cell phone networks, but also closed communication networks established for each predetermined administrative region, such as wireless LAN, Wi-Fi (registered trademark), and Bluetooth (registered trademark).

The in-vehicle device 30 is installed in various a vehicle 20. The vehicle 20 includes a plurality of vehicles 20-1, 20-2, . . . , 20-n The vehicle 20 may be a manual driving vehicle or a self-driving vehicle. The vehicle 20 may include vehicles of which the models or grades are different.

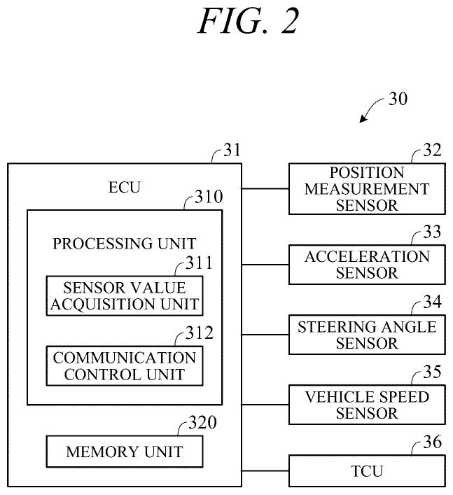

FIG. 2 is a block diagram illustrating the key components of the in-vehicle device 30 according to the present embodiment. The in-vehicle device 30 has an electronic control unit (ECU) 31, a position measurement sensor 32, an acceleration sensor 33, a steering angle sensor 34, a vehicle speed sensor 35, and a telematic control unit (TCU) 36.

The position measurement sensor 32 is, for example, a GPS sensor, which receives positioning signals transmitted from GPS satellites and detects the absolute position (e.g., latitude and longitude) of the vehicle 20. The position measurement sensor 32 includes not only GPS sensors but also sensors that use radio waves transmitted from satellites in various countries, known as GNSS satellites, including quasi-zenith orbit satellites. Alternatively, the vehicle position may be determined by a hybrid method with inertial navigation.

The acceleration sensor 33 detects the acceleration of the vehicle 20 in the left-right directions, that is, lateral acceleration. The acceleration sensor 33 may be configured to detect acceleration in the front-back direction and vertical direction as well as lateral acceleration of the vehicle 20. The steering angle sensor 34 detects the steering angle of the steering wheel (not shown) of the vehicle 20. The vehicle speed sensor 35 detects the vehicle speed of the vehicle 20.

As illustrated in FIG. 2, the ECU 31 includes a computer including a processing unit 310 such as a CPU (processor), a memory unit 320 such as ROM and RAM, and other peripheral circuits such as I/O interfaces not illustrated. The processing unit 310 functions as a sensor value acquisition unit 311 and a communication control unit 312 by executing a program stored in the memory unit 320 in advance.

The sensor value acquisition unit 311 acquires information (values) detected by each of the sensors 32 to 35. Particularly, the sensor value acquisition unit 311 acquires lateral acceleration detected by the acceleration sensor 33, a driving speed detected by the vehicle speed sensor 35, and the absolute position of the vehicle 20 detected by the position measurement sensor 32 at a predetermined cycle, for example, every 10 ms. The communication control unit 312 transmits the information acquired by the sensor value acquisition unit 311 (hereinafter referred to as driving information) to the road surface evaluation apparatus 10 via the TCU 36, together with the detection time information indicating the detection time thereof and the vehicle ID that can identify the vehicle 20 (vehicle identification information). At this time, the communication control unit 312 transmits the information acquired by the sensor value acquisition unit 311 at a predetermined cycle. More specifically, the communication control unit 312 transmits the information acquired by the sensor value acquisition unit 311 in intervals of, for example, 1 s so as not to increase the processing load and not to unnecessarily squeeze the bandwidth of the communication network 2.

The road surface evaluation apparatus 10 detects the unevenness of the road surface, that is, the road surface roughness (hereinafter also referred to as a road surface profile), based on the values detected by the acceleration sensor 33 of the vehicle 20 (in-vehicle device 30). The detected road surface profile is output to a terminal owned by, for example, a road management company, and is used as reference data by the road management company when considering whether or not repairs are necessary. That is, the detected values of the acceleration sensor 33 are used to evaluate the road surface profile.

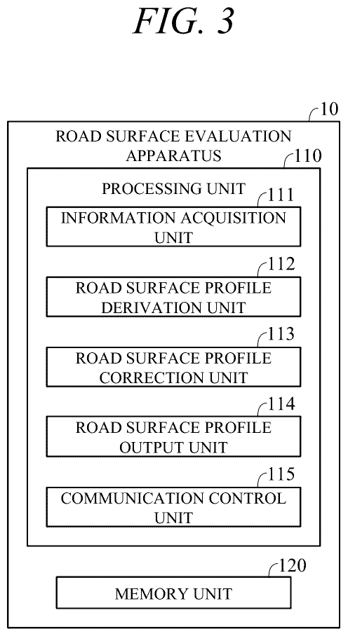

FIG. 3 is a block diagram illustrating the key components of the road surface evaluation apparatus 10 according to the present embodiment. The road surface evaluation apparatus 10 is configured to include a computer including a processing unit 110, such as a CPU, a memory unit 120 such as ROM and RAM, and other peripheral circuits such as I/O interfaces not illustrated. The memory unit 120 stores map information including road maps, and various information processed by the processing unit 110.

The processing unit 110 functions as an information acquisition unit 111, a road surface profile derivation unit 112, a road surface profile correction unit 113, a road surface profile output unit 114, and a communication control unit 115 by executing programs stored in the memory unit 120.

The information acquisition unit 111 acquires driving information. In more detail, the information acquisition unit 111 receives the driving information from the in-vehicle device 30 of each of the plurality of vehicles 20 traveling on the road, via the communication control unit 115. Note that the information acquisition unit 111 can identify the vehicle 20 that is the transmission source of the driving information by the vehicle ID associated with the driving information.

The information acquisition unit 111 stores driving information received from the plurality of vehicles 20 (in-vehicle devices 30) in the memory unit 120 in time series. Hereafter, the driving information stored in time series in the memory unit 120 is referred to as time-series driving information. The information acquisition unit 111 also acquires map information from the memory unit 120, including information on the road on which the vehicles 20 are driving.

The road surface profile derivation unit 112 derives roughness information indicating the amount of unevenness (depth or height) of the road surface, or road surface roughness, based on the driving information acquired by the information acquisition unit 111. Roughness information is a road surface roughness value that indicates the degree of roughness of the road surface, for example, the value expressed by the International Roughness Index (IRI), which is an international index. Hereinafter, the road surface roughness values may be simply referred to as roughness values. The road surface profile derivation unit 112 stores the derived road surface roughness values in time series into the memory unit 120.

In general, the greater the amount of unevenness of the road surface, the greater the lateral acceleration of the vehicles 20, and the road surface roughness values and the lateral acceleration have a certain correlation. The road surface profile derivation unit 112 uses this correlation to derive the road surface roughness value corresponding to the vehicle position on the road from the lateral acceleration. Specifically, the road surface profile derivation unit 112 first derives a correlation between road surface roughness values and lateral acceleration based on the previously measured road surface roughness values and lateral acceleration.

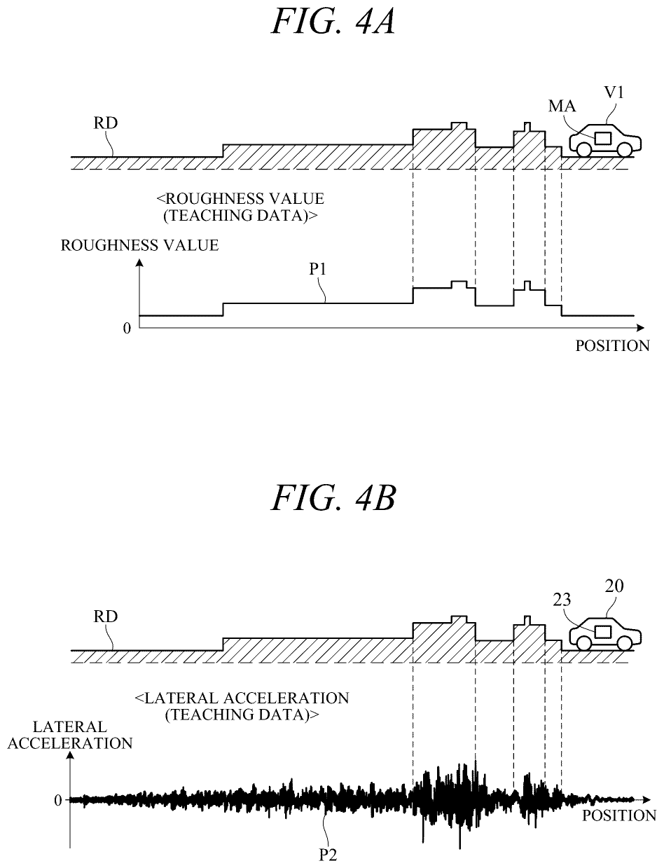

FIGS. 4A and 4B illustrate how the correlation between road surface roughness values and lateral acceleration is derived. A vehicle V1 illustrated in FIG. 4A is a special vehicle including a measuring instrument MA that measures road surface roughness. When the vehicle V1 is driving on a predetermined road (such as a course for measurement) RD, the measuring instrument MA measures road surface roughness values of the road RD. A characteristics P1 in FIG. 4A represents the road surface roughness values measured at this time, that is, the road surface roughness values used as the training data.

FIG. 4B illustrates the vehicle 20 in FIG. 1 driving on the same road RD as that in FIG. 4A. A characteristic P2 in FIG. 4B represents the lateral acceleration detected by the acceleration sensors 33 installed in the vehicles 20, that is, the lateral acceleration used as the training data, while the vehicles 20 are driving on the predetermined road RD.

The training data for road surface roughness values and lateral acceleration may be stored in the memory unit 120 of the road surface evaluation apparatus 10 or in an external memory device. The road surface profile derivation unit 112 executes machine learning using the training data for road surface roughness values and lateral acceleration read from the memory unit 120 or an external storage device to derive the correlation between the road surface roughness values and the lateral acceleration. A driving speed, front/rear acceleration, and a steering angle may be added as training data for machine learning.

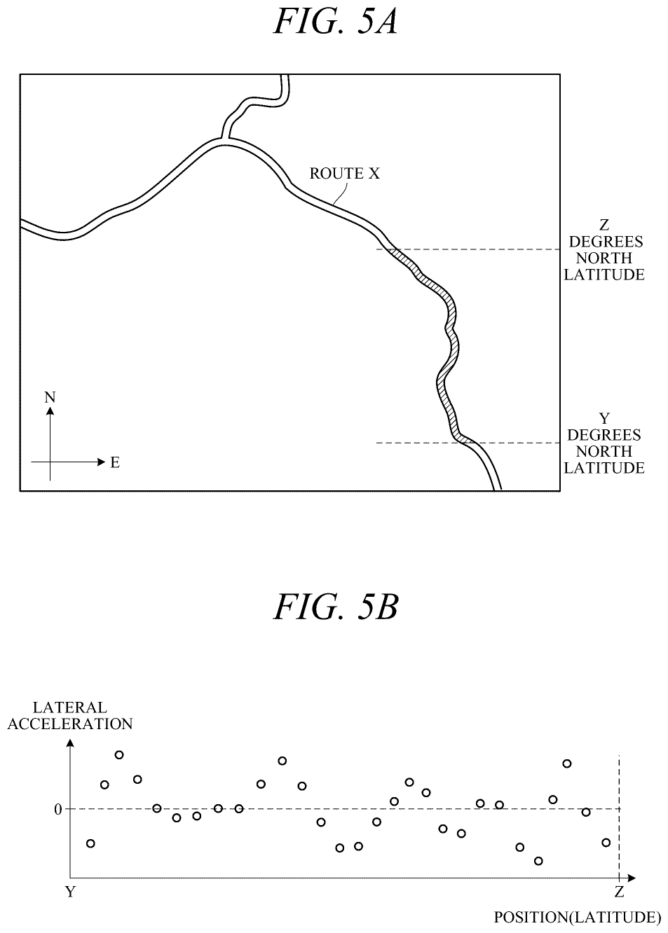

FIG. 5A illustrates an example of a map of the road on which the vehicle 20 is driving. FIG. 5A illustrates a predetermined road (a section with latitude Y to Z on National Route X) to be evaluated for road surface roughness. In FIG. 5A, the upper direction corresponds to the north direction, and the right direction corresponds to the east direction. A range to be evaluated for road surface roughness (hereinafter referred to the road to be evaluated) can be designated by a user as will be described later. In a case where the road to be evaluated has a plurality of lanes on each side, a lane to be evaluated for road surface roughness is designated by the user. FIG. 5B illustrates an example of driving information acquired by the road surface evaluation apparatus 10 from the in-vehicle device 30 of the vehicle 20 that drove on the predetermined road (the section of latitude Y to Z on National Route X) in FIG. 5A. The horizontal axis in the figure is a position (latitude) of the vehicle 20 in a driving direction along a traveling lane, and the vertical axis is the lateral acceleration of the vehicle 20.

Meanwhile, the lateral acceleration detected by the acceleration sensor 33 while the vehicle 20 is driving changes depending on a weather at a location where the vehicle travels. For example, when the vehicle travels on water covering a road surface during rainfall, the buoyancy of water applied to the tire or noise due to water splash generated from the tire is detected by the acceleration sensor 33, and it may be difficult to detect the lateral acceleration of the vehicle 20 with high accuracy. When there is a strong wind, noise due to wind pressure applied to the vehicle 20 is detected by the acceleration sensor 33, and it may be difficult to detect the lateral acceleration of the vehicle 20 with high accuracy. At the time of snowfall, since a coefficient of friction between the tires and the road surface decreases, or the unevenness of the road surface changes due to the snow cover, it may be difficult for the acceleration sensor 33 to detect the lateral acceleration corresponding to the actual unevenness of the road surface.

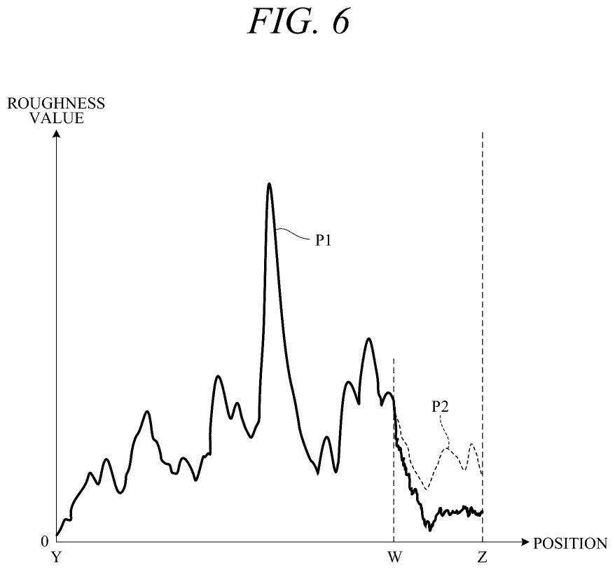

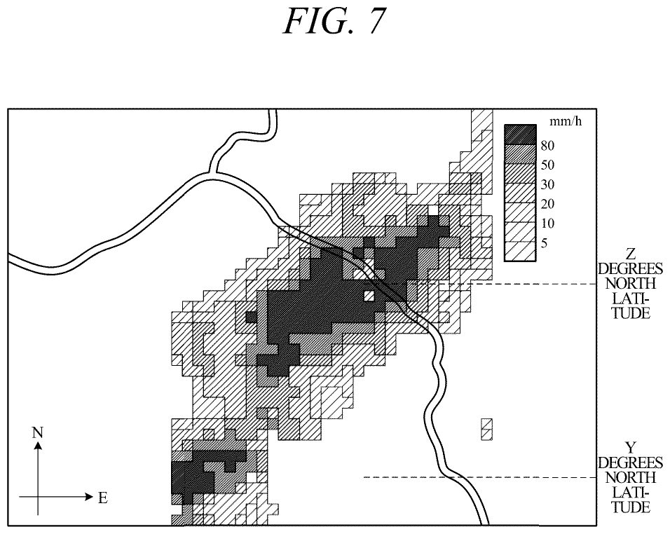

Therefore, in the weather as described above, the road surface roughness value derived based on the lateral acceleration of the vehicle 20 may be less accurate. Hereinafter, rain, snow, strong wind, a low temperature, and a high temperature, more particularly, rain equal to or more than a predetermined rainfall amount, snow equal to or more than a predetermined snowfall amount, strong wind having a speed equal to or higher than a predetermined wind speed, a low temperature equal to or lower than a predetermined temperature, and a high temperature equal to or higher than a predetermined temperature are described as bad weather. FIG. 6 is a graph illustrating an example of a road surface roughness value in bad weather. A characteristic P1 in the figure denotes a road surface roughness value derived from driving information (acceleration information) acquired from the in-vehicle device 30 of the vehicle 20 driving on the predetermined road in FIG. 5A. FIG. 7 is a diagram illustrating an example of weather information of the predetermined road in FIG. 5A. FIG. 7 illustrates precipitation amount information at the time when the driving information used to derive the road surface roughness value of FIG. 6 is acquired, more particularly, when the vehicle 20 is driving near the latitude Z of National Route X. The weather information includes precipitation amount information, snowfall amount information, wind speed information, temperature information, or the like.

As illustrated in FIG. 6, in a section where it is estimated that there is heavy rain with a precipitation amount of 80 mm/h or more (the latitudes W to Z of National Route X), the lateral acceleration of the vehicle 20 is not accurately detected due to the effect or the like of water covering the road surface, and a road surface roughness value different from that in good weather is derived. In FIG. 6, a road surface roughness value (characteristic P2) derived based on the driving information acquired by the in-vehicle device 30 when the vehicle 20 travels in the above section (the latitude W to Z of National Route X) in good weather is represented by a broken line.

As described above, even in a case where the vehicle 20 travels on the same road, the road surface roughness value derived based on the driving information of the vehicle 20 varies depending on weather during traveling. In particular, in bad weather, the road surface roughness value derived based on the lateral acceleration of the vehicle 20 is likely to be less accurate. In consideration of this point, the road surface profile correction unit 113 corrects the road surface roughness value derived by the road surface profile derivation unit 112 on the basis of the weather information of the section where the vehicle 20 has traveled. Note that the weather information is acquired by the information acquisition unit 111 via the communication control unit 115 from an external server or the like that distributes the weather information.

Here, correction of the road surface roughness value using the weather information will be described. When the information acquisition unit 111 acquires the driving information via the communication control unit 115, weather information of a driving position of the vehicle 20 is acquired based on the position information included in the driving information. Note that the in-vehicle device 30 may receive weather information of a current position of the vehicle 20 from an external server or the like via the TCU 36, and transmit the received weather information together with the driving information to the road surface evaluation apparatus 10. The information acquisition unit 111 stores the driving information and the weather information in association with each other in the memory unit 120.

The road surface profile correction unit 113 estimates weather in a section where the vehicle 20 has traveled on the basis of the weather information acquired by the information acquisition unit 111, and corrects the road surface roughness value derived by the road surface profile derivation unit 112 on the basis of the estimation result.

Specifically, the road surface profile correction unit 113 reads, from the memory unit 120, the weather information associated with the driving information used to derive the road surface roughness value. Based on the read weather information, the road surface profile correction unit 113 determines whether or not a section where the vehicle 20 has traveled includes a location where the weather was bad at the time of driving, that is, whether or not the vehicle 20 has traveled at a location where the weather is bad. The road surface profile correction unit 113 estimates duration of the bad weather on the basis of the read weather information when the location where the weather was bad when the vehicle 20 has traveled is included. The road surface profile correction unit 113 deletes, from the memory unit 120, the road surface roughness value derived based on the driving information acquired at the location in a period in which the bad weather is estimated to continue.

The road surface profile output unit 114 outputs the road surface roughness value stored in the memory unit 120 in association with the road information acquired by the information acquisition unit 111.

The communication control unit 115 controls a communication unit (not illustrated) to transmit and receive data to and from external devices and others. In more detail, the communication control unit 115 transmits and receives data via the communication network 2 to and from the in-vehicle device 30 of the vehicle 20 and terminals of road management companies or the like. The communication control unit 115 also receives, via the communication network 2, a road surface profile output instruction transmitted from the terminals of road management companies or the like. In addition, the communication control unit 115 acquires map information and other information from various servers connected to the communication network 2 periodically or at arbitrary times. The communication control unit 115 stores, in the memory unit 120, information that has been acquired from various servers.

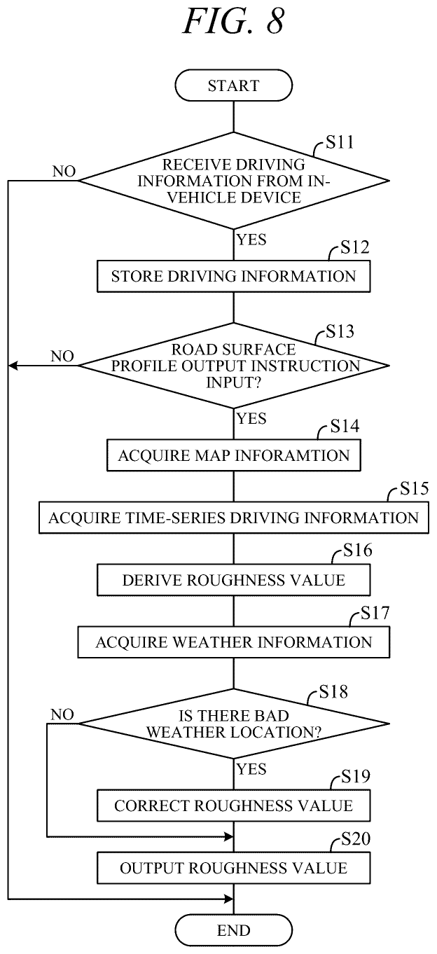

FIG. 8 is a flowchart illustrating an example of processing executed by the processing unit 110 (CPU) of the road surface evaluation apparatus 10 according to a predetermined program. The processing illustrated in this flowchart is repeated at a predetermined cycle while the road surface evaluation apparatus 10 is running. First, in step S11, it is determined whether driving information has been received from the in-vehicle device 30 of the vehicle 20. If NO in step S11, the processing ends. If YES in step S11, in step S12, the weather information of the driving position of the vehicle 20 is acquired based on the position information included in the driving information received in step S11, and then the driving information and the weather information are stored in the memory unit 120 in association with each other. At this time, the vehicle ID is also stored in the memory unit 120. In step S13, it is determined whether or not a road surface profile output instruction has been input (received).

The road surface profile output instruction includes section information that can identify the road to be evaluated. The section information is information that indicates the name and section of the road to be evaluated, for example, “road: National Route X, section: latitude Y to Z”. When the road has a plurality of lanes on each side, such as two lanes on one side, the section information may include information on the lane to be evaluated, such as “road: National Route X, lane: right end, section: latitude Y to Z”. Information other than latitude may be used to specify the section to be evaluated. For example, longitude may be used instead of latitude or in addition to latitude. Alternatively, the distance from the start point of the section may be used. The road surface profile output instruction further may include period information specifying a predetermined period to be evaluated. The period information includes information that can identify the period to be evaluated, for example, “the past one month from” month or “within the past year from the present”.

If NO in step S13, the processing ends. If YES in step S13, in step S14, map information is read from the memory unit 120 and road information included in the map information is acquired. In step S15, driving information (time-series driving information) of the vehicles 20 is acquired from the memory unit 120. In more detail, based on section information included in the road surface profile output instruction and the road information acquired in step S14, driving information corresponding to the road to be evaluated which is identified by the section information is read from the memory unit 120. Note that, when the section information and period information are included in the road surface profile output instruction, of items of the driving information corresponding to the road to be evaluated which is identified by the section information, driving information acquired during a predetermined period designated by the period information is read from the memory unit 120.

In step S16, a road surface roughness value is derived based on each item of driving information read from the memory unit 120 in step S15, and the derived road surface roughness value is stored as an output target in the memory unit 120. In step S17, weather information associated with the driving information read from the memory unit 120 in step S15 is read from the memory unit 120.

In step S18, based on the weather information read in step S17, it is estimated whether or not the vehicle 20 has traveled a location where the weather is any one of rain, snow, strong wind, a low temperature, and a high temperature (hereinafter, referred to as a bad weather location). At this time, when the weather information read in step S17 includes information indicating any one of rain, snow, strong wind, a low temperature, and a high temperature, it is determined that the vehicle 20 has traveled through the bad weather location. If NO in step S18, the processing proceeds to step S20.

If Yes in step S18, the road surface roughness value derived in step S16 is corrected in step S19. Particularly, of the road surface roughness values stored in the memory unit 120 in step S16, a road surface roughness value derived based on the driving information corresponding to the bad weather location is excluded from output targets. The road surface roughness value excluded from the output targets is deleted from the memory unit 120. The driving information corresponding to the bad weather location is driving information acquired by the in-vehicle device 30 while the vehicle 20 is driving at the bad weather location.

In step S20, an output target road surface roughness value is read from the memory unit 120, and information obtained by associating the read road surface roughness with the road information acquired in step S14, that is, road surface profile information, is generated and output. In more detail, information obtained by associating the read road surface roughness value with each position of the section designated by an output instruction is output as the road surface profile information. The road surface profile information is output via the communication network 2 to a terminal from which the road surface profile output instruction is transmitted or to a predetermined output destination terminal. The road surface profile information is information that can be displayed on a display device such as a display, and users can check and evaluate road surface profiles by displaying the road surface profile information on a display included in the user's terminal.

According to the embodiment of the present invention, the following effects can be achieved.
(1) The road surface evaluation apparatus 10 includes the information acquisition unit 111 that acquires the driving information of the vehicle 20 including the acceleration information indicating the acceleration of the vehicle 20 which is driving and the position information of the vehicle 20, the map information including the information on a road on which the vehicle 20 travels, and the weather information including information relating to weather; the road surface profile derivation unit 112 that derives the road surface roughness value representing roughness of the road surface on which the vehicle 20 travels on the basis of the driving information of the vehicle 20 acquired by the information acquisition unit 111; the road surface profile correction unit 113 that estimates weather in a section where the vehicle 20 has traveled on the basis of the weather information acquired by the information acquisition unit 111, and corrects the road surface roughness value derived by the road surface profile derivation unit 112 on the basis of the estimation result; and the road surface profile output unit 114 that outputs the road surface roughness value corrected by the road surface profile correction unit 113 in association with the road information acquired by the information acquisition unit 111 (FIG. 3).

This configuration enables a road surface profile that can be sufficiently evaluated to be derived independent of the weather in which the vehicle 20 travels on the road. This configuration also enables a road surface profile of a road to be sufficiently evaluated using driving information of general vehicles without using a special vehicle for road surface profile measurement. Furthermore, users such as road management companies can estimate which roads need to be repaired based on the road surface profile output by the road surface evaluation apparatus 10 without having to visit the site, thereby reducing the cost of road management.
(2) When the section where the vehicle 20 has traveled includes the location where the weather during traveling is any one of rain, snow, strong wind, a low temperature, and a high temperature, the road surface profile correction unit 113 deletes a road surface roughness value corresponding to the location from the road surface roughness values derived by the road surface profile derivation unit 112. Specifically, the road surface profile correction unit 113 deletes, from the road surface roughness values derived by the road surface profile derivation unit 112, a road surface roughness value corresponding to the location, that is, a road surface roughness value corresponding to a period during which it is estimated that the weather continues at the location. This results in highly accurate evaluation of the road surface profile, since the road surface roughness value corresponding to the bad weather location is not used for the evaluation of the road surface profile.

The above embodiment can be modified into various examples. Hereinafter, modification examples will be described.

### First Modification Example

In general, weather such as rain or snow continuously affects a road surface even after the weather has improved. A duration time thereof varies depending on a position of the road, an inclination angle of the road surface, a type of pavement, or the like. Therefore, for example, the time during which a road surface is covered with water after rainfall may be different between the vicinity of the latitude Y and the vicinity of the latitude Z of National Route X in FIG. 7.

Therefore, in consideration of this point, in the present modification example, when it is estimated that the vehicle 20 has traveled through a bad weather location while driving in an evaluation target section, the road surface profile correction unit 113 estimates the time during which bad weather continuously affects a road surface at the bad weather location (hereinafter referred to as an effect duration time). The road surface profile correction unit 113 excludes, from output targets of the road surface profile output unit 114, driving information acquired when the vehicle 20 travels through the bad weather location until the effect duration time passes.

Note that the effect duration time is determined in advance on the basis of types of weather, types of pavement, an inclination angle of a road surface, or the like at each location of a road on a map. The memory unit 120 stores an effect duration time table in which an effect duration time of each location determined in advance for each type of weather is associated with position information (latitude and longitude) of each location. The road surface profile correction unit 113 estimates the effect duration time at the bad weather location on the basis of the effect duration time table. Particularly, the effect duration time of the bad weather location is estimated on the basis of the effect duration time corresponding to the type of weather at the bad weather location, which is the effect duration time of the location closest to the bad weather location among the effect duration times registered in the effect duration time table. Note that a representative value such as an average value or a median value calculated from the effect duration times of one or a plurality of locations positioned within a predetermined distance from a bad weather location may be estimated as the effect duration time at the bad weather location. When the same location as the bad weather location is registered in the effect duration time table, the effect duration time stored in the effect duration time table may be used as it is.

Note that the effect duration time may vary depending on types of bad weather such as rain or snow. Therefore, the effect duration time table may store individual effect duration times corresponding to the types of bad weather. In this case, the road surface profile correction unit 113 determines a type of weather at the bad weather location on the basis of the weather information acquired by the information acquisition unit 111, and acquires, from the effect duration time table, an effect duration time corresponding to the type of weather at the bad weather location.

The above embodiment can be modified into various forms. Hereinafter, modifications will be described. In the above embodiment, the information acquisition unit 111 acquires the lateral acceleration of the vehicle 20 detected by the acceleration sensor 33 as information indicating the motion of the vehicle 20 as the driving information acquisition unit, but the information indicating the motion of vehicle 20 is not limited to the lateral acceleration of the vehicle 20 detected by the acceleration sensor. In other words, any configuration of the information acquisition unit 111 may be used, such as that detecting the front/rear acceleration, as long as it acquires information indicating the motion of the vehicle 20.

In the above embodiment, the information acquisition unit 111 functions as a map information acquisition unit to acquire, from the memory unit 120, map information including information about the road on which the vehicles 20 travel, but the map information may be stored on an external server or an external storage device. That is, any configuration of the map information acquisition unit may be used as long as the unit acquires map information including information about a road on which the vehicle 20 travels.

In the above embodiment, the road surface profile correction unit 113 functions as a roughness value correction unit to delete, from the memory unit 120, the road surface roughness value excluded from the output targets of the road surface profile output unit 114. However, the roughness value correction unit may instruct the road surface profile output unit 114 to exclude the road surface roughness value derived based on the driving information corresponding to the bad weather location from the output targets without deleting the road surface roughness value excluded from the output targets from the memory unit 120.

In the above embodiment, when the information acquisition unit 111 acquires the driving information via the communication control unit 115, the weather information at the driving position of the vehicle 20 is acquired based on the position information included in the driving information. However, a configuration of a weather information acquisition unit is not limited thereto. The weather information acquisition unit may acquire weather information each time a predetermined number of items of driving information are acquired via the communication control unit 115. The acquired weather information may be stored in the memory unit 120 in association with the predetermined number of items of driving information.

The road surface profile correction unit 113 may function as a roughness value derivation unit correct the road surface roughness value derived by the road surface profile derivation unit 112, on the basis of a vehicle speed detected by the vehicle speed sensor 35 and a steering angle detected by the steering angle sensor 34. When the vehicle 20 travels on a curved road, the acceleration sensor 33 detects not only the lateral acceleration due to the unevenness of the road surface, but also the lateral acceleration due to centrifugal force generated according to the speed and the steering angle of the vehicle 20. Therefore, in such a case, the road surface profile correction unit 113 may correct the road surface roughness value to eliminate a component based on the lateral acceleration due to the centrifugal force from the road surface roughness value derived based on the lateral acceleration detected by the acceleration sensor 33. This enables the road surface roughness value for a road other than the straight road to be derived with high accuracy.

In the above embodiment, the road surface profile output unit 114 functions as an output unit to output the road surface profile information to the user's terminal, but the output unit may output the road surface profile information to the memory unit 120 so that the road surface profile information is mapped to the map information stored in the memory unit 120. That is, any configuration of the output unit is acceptable as long as it outputs road surface profile information.

In the above embodiment, the road surface profile derivation unit 112 as the roughness value derivation unit derives the road surface roughness values expressed in terms of IRI, but the road surface roughness values may be expressed in terms of other indices. For example, if the road surface roughness values acquired as training data are represented in terms of an index other than IRI, the road surface profile derivation unit 112 may derive the road surface roughness values represented by that index.

The present invention can be used as a method for evaluating a road surface which includes a process causing a computer to execute: the step (S15) of acquiring the driving information of the vehicle 20 which includes the acceleration information indicating the acceleration of the vehicle 20 which is traveling and the position information of the vehicle 20; the step (S14) of acquiring the map information including information about the road on which the vehicle 20 is driving; the step (S17) of acquiring weather information including information relating to weather; the step (S16) of deriving the road surface roughness value representing roughness of the road surface on which the vehicle 20 travels on the basis of the acquired driving information of the vehicle 20; the steps (S18 and S19) of estimating weather in a section where the vehicle 20 has traveled on the basis of the acquired weather information and correcting the road surface roughness value on the basis of an estimation result; and the step (S20) of outputting the corrected road surface roughness value in association with the acquired road information.

The above explanation is an explanation as an example and the present invention is not limited to the aforesaid embodiment or modifications unless sacrificing the characteristics of the invention. The aforesaid embodiment can be combined as desired with one or more of the aforesaid modifications. The modifications can also be combined with one another.

### REFERENCE SIGNS LIST

10 road surface evaluation apparatus, 20, 20-1 to 20-n vehicle, 30 in-vehicle device, 110 processing unit, 11 information acquisition unit, 112 road surface profile derivation unit (roughness information derivation unit), 113 road surface profile correction unit, 114 road 10 surface profile output unit (output unit), 120 memory unit

1-5. (canceled)

6. A road surface evaluation apparatus comprising
a microprocessor configured to perform:
acquiring driving information of a vehicle which is traveling including acceleration information indicating accelerations of the vehicle, speed information indicating driving speed of the vehicle, and position information of the vehicle;
acquiring map information including information on a road on which the vehicle travels;
acquiring weather information including information relating to weather;
deriving road surface roughness values representing roughness of a road surface on which the vehicle travels based on the driving information of the vehicle;
correcting the road surface roughness values based on a result of estimating the weather in a section where the vehicle has traveled based on the weather information; and
outputting the road surface roughness values as corrected in association with the information on the road.

7. The road surface evaluation apparatus according to claim 6, wherein
the microprocessor is configured to perform
the correcting including, when the section where the vehicle has traveled includes a bad weather location where the weather during traveling is bad weather which is any one of rain, snow, strong wind, a low temperature, and a high temperature, deleting the road surface roughness value corresponding to the bad weather location from the road surface roughness values.

8. The road surface evaluation apparatus according to claim 7, wherein
the microprocessor is configured to perform
the correcting including deleting, from the road surface roughness values, the road surface roughness value corresponding to the bad weather location and corresponding to a period during which it is estimated that the bad weather continues at the bad weather location.

9. The road surface evaluation apparatus according to claim 8, wherein
the microprocessor is configured to perform
the correcting including deleting, from the road surface roughness values, the road surface roughness value corresponding to the bad weather location and corresponding to a period during which it is estimated that an effect of the bad weather continues at the bad weather location.

10. The road surface evaluation apparatus according to claim 9 further comprising
a memory connected to the microprocessor and configured to store an effect duration time indicating a time in which the effect of the bad weather on a road surface continues determined in advance for each type of weather in associated with the position information of each of a plurality of locations included in the map information, wherein
the microprocessor is configured to perform
the correcting including reading the effect duration time corresponding to a position of the bad weather location and the bad weather from the memory to estimate a period in which the effect by the bad weather continues at the bad weather location based on the effect duration time.
